(19) United States
(12) Patent Application Publication
(10) Pub. No.: US 2013/0149161 A1
(43) Pub. Date: Jun. 13, 2013

(54) Conical wind turbine

(71) Applicant: STEVE B. LACASSE, PORT ST. LUCIE, FL (US)

(72) Inventor: STEVE B. LACASSE, PORT ST. LUCIE, FL (US)

(21) Appl. No.: 13/573,022

(22) Filed: Aug. 14, 2012

Related U.S. Application Data
(60) Provisional application No. 61/567,996, filed on Dec. 7, 2011.

(51) Int. Cl. F03D 1/06

(52) U.S. Cl. 416/223 R

(57) ABSTRACT

A wind turbine comprising a rotor having a shallow slope cone configuration on a horizontal axis with its apex facing the wind and its base downstream. A plurality of circumaxially-spaced wind engaging vanes are mounted on the surface of the rotor. Each vane has an elongated substantial flat entry surface projecting substantially at right angles from the surface of the rotor for engagement by the wind and the surface of the vane being displaced angularly front to rear from the axis of the rotor so as to be engaged by the wind and drive the rotor.

### RELATED APPLICATIONS

Reference is had to Provisional applications filed respectively on Aug. 19 and Dec. 7, 2011 under the name Steve Brian LaCasse, 143 SW South Danville Circle, Port Saint Lucie, Fla. 34953, application No. 61/567,996.

### BACKGROUND OF THE INVENTION

The use of wind turbines to convert wind energy to electricity is widespread and expanding rapidly. Conventional wind turbine systems, however, are not suitable for use in close proximity to populated areas or in rooftop applications due to the high levels of noise and which they generate. They are also inefficient in regions with low average wind speed, and may be harmful to wildlife, unappealing aesthetically, and are not readily adaptable to underwater applications.

These systems typically include a tower, a large horizontal axis wind turbine, gearbox, brake system, starter motor, and generator enclosed in a nacelle. The turbine has blades similar to airplane propellers or airfoils. Medium and large wind turbines usually have blade pitch control devices to facilitate start-up and to control rotor speed. Smaller wind turbines rotors may be fixed directly to the hub. The hub for medium and large wind turbines may be attached to a low-speed shaft coupled to a gearbox and then the electric generator. Smaller wind turbines are mostly direct drive, the hub being attached to a shaft that connects directly with the generator. In many systems, a starter motor is utilized for large wind turbines to assist blade rotation until sufficient wind continues to rotate the blades and the generator.

### Noise Emission

As mentioned, there are several problems with conventional large wind turbine systems, the most prominent being the noise issue. There are two sources of wind turbine noise: aerodynamic and mechanical. Aerodynamic noise is produced by the flow of the wind over the blade trailing edges and tips. Mechanical noise arises from the meshing of transmission gears and the generator.

The SPL (Sound Pressure Level) noise factor generated by wind turbines is the most frequent community concern. Noise is also critical in siting small and medium wind turbines, however, the smaller the wind turbine, the less noise they produce and the closer they are likely to be located to residential areas and the like.

Noise, unlike visual aesthetic intrusion, is measurable, and serves as the lightning rod for almost all potential applications. As stated, all of today's wind turbines create unwanted noise, some to a greater degree than others. Noise is measured in decibels (dB), and SPLs in dBA. The decibel scale spans the range from the threshold of hearing, zero dBA, to the threshold of pain, 140 dBA.

Most communities have a local noise ordinance for day and night. The residential daytime SPL limit is usually between 45 to 65 dBA and the night SPL limit from 35 to 55 dBA, depending on the municipality.

The distance from a wind turbine to the listener is as important as the noise level at the source. When noise is presented as SPL, the location is always specified, because sound levels of course decrease with increased distance as the sound propagates away from the source. Typical wind turbines, however, can be heard above ambient noise at great distances. This scenario increases location and installation costs significantly, and limits potential applications.

For purposes of comparison, a jet engine will produce 100 dBA at a distance of 200 feet; a jackhammer 100 dBA at 50 feet and a vacuum cleaner, 70 dBA at 10 feet.

Medium to large MW (megawatt) wind turbines generate from 90 dBA to more than 100 dBA, and require considerable property around their perimeter to create a buffer zone. Small kW (kilowatt) wind turbines at wind speeds of only 8 m/s (18 mph) may generate 82 dBA to more than 100 dBA. One-reason small wind turbines are mounted on tall towers, other than exposure to more wind speed at the high elevation, is to increase the distance from the rotor, the source of the noise, to the listener. The SPLs and vibration generated by currently available small wind turbines is the primary reason why commercial and residential rooftop installations are not utilized.

Advances in airfoil (propeller) design have reduced the sound pressure level minimally over the past 30 years. The higher the rotor RPM, the greater the SPL produced. The most popular industry method to lower noise emissions therefore has been to reduce rotor speed by braking or yawing. This, of course, is counter-productive!

Wind turbine noise must be dealt with at the source, the rotor!

To address the foregoing and or other issues, a general object of the present invention is to provide residential and commercially viable wind turbine systems that are suitable to location within populated regions, have at least 75% reduced installation footprint, are more effective in areas with lower than average wind speeds, generate substantially lower decibel sound levels, create little or no hazard to wildlife, and have visually appealing aesthetics.

### Power Efficiency

Power is directly related to the area intercepting the wind. Wind turbines with large rotors obviously intercept more area than those with smaller rotors, and therefore, produce more power.

The area of a wind stream swept by a wind turbine rotor is known as the “swept area.” For a conventional wind turbine rotor, the swept area is the area of a circle:

A(area)=Pi(3.14)×R(radius)squared

For a conical turbine rotor the swept area is the surface area of the cone:

A(area)=Pi(3.14)×R(radius)×S(slant length)

Thus, the swept area of a conical 7′ diameter rotor having a 20-degree slope is approximately 6% greater than a conventional 7′ diameter propeller rotor swept area.

There is nothing beyond rotor design itself, no other single parameter, that is more important in determining rotor capability for capturing energy in the wind than the area swept by the rotor. Conventional rotors allow most of the wind to pass through unimpeded. Power produced relates to the amount of wind striking rotor blades perpendicular to the wind, compared to the amount flowing through.

A conical turbine rotor swept area is solid thus it captures, deflects, concentrates and expels almost 100% of the wind that strikes its entire swept area.

Intuitively a multi-blade rotor would capture more wind than a modern turbine machine with only two or three blades. That is, the rotor should have more blades to capture more wind. If we carry this concept to its logical extreme, the optimal rotor would cover the entire swept area with blades, producing a solid disk (perpendicular to the wind stream). The air would not pass through, but would instead pile up in front of the rotor. Thus, rather than capturing more wind, the rotor wouldn't capture any. Obviously, there must be some air moving through the rotor and it must retain enough kinetic energy to keep moving and make way for the air behind.

Global wind turbine industry rotor designs are based on the aforementioned criteria as it relates to the “Betz Limit”. The wind turbine industry has had to strike a balance between a rotor that completely stops the wind and one that allows the wind to pass through unimpeded; between the amount of wind striking the rotor blades and the amount flowing through. German scientist Albert Betz demonstrated mathematically in 1920 that this optimum is reached when the rotor reduces wind speed by one third. By considering the winds momentum as it passes through the rotor, Betz calculated that the maximum a theoretical wind turbine rotor could capture was 16/27 or 59.3% of the energy in the wind. However, the “Betz Limit” is of course, theoretical.

The most efficient of the three-blade or other multi-blade rotors available today have only achieved approximately 40% of the “Betz Limit,” due to losses caused by aerodynamic drag around the blade tips, losses due to the opposite rotation of the wake behind the rotor, drag on the fast moving blades and tip losses from increased pressure around the end of the blades on rotors using a few slender airfoils. This results in more air flowing around rather than over the blade, one reason for tip vanes at the end of wings on large aircraft today.

Wind turbine manufacturers utilize the term “start-up wind speed,” the minimum wind speed at which a wind turbine rotor at rest will begin to rotate. Another industry term utilized is “cut-in wind speed,” when the wind turbine begins producing usable power. Due to the efficiency of a conical turbine rotor, however when combined with the appropriate alternator, the two terms may be the same.

The wind turbine industry average for “cut-in speed” is 8-10 mph wind or 3.58-4.47 m/s. On the other hand, test results show the conical turbine rotor start-up wind speed to be less than one mph or 0.045 m/s. The Vortex anemometer utilized for the wind test, does not record wind speeds less than one mph, therefore, all can be stated is that conical 7′ diameter wind turbine rotor start-up speed is less than one mph wind. Lets consider the following 7′ diameter conical rotor low wind outdoor test results below, remembering that the industry average cut-in speed is 8-10 mph winds:

| Wind Speed MPH/M/S | Torque Ft. Lbs./Nm | RPM |
|---|---|---|
| 5.2/2.325 | 41.5/56.44 | 33.87 |
| 6.4/2.861 | 53.0/72.08 | 42.69 |

Conventional 7′ diameter or larger wind turbine rotors available on the market today will not produce any power whatsoever at the wind speeds shown above. A conventional three-blade wind turbine rotor requires wind speeds of 16 mph plus to produce the torque and RPM that the conical 7′ diameter wind turbine rotor produces in a 5.2 mph wind. Thus, a conical wind turbine rotor produces three times the torque or power of conventional rotors at low wind speeds.

Most 7′ diameter or larger wind turbine OEMs will state that annual average wind speeds of 10 mph plus are required to justify the installation and ROI (Return On Investment) of their wind turbine system.

It is a general object one of the present invention to provide a dramatically improved wind turbine with regard to both performance and noise generation.

Another object of the present invention is to provide a wind turbine having a solid conical swept area rotor incorporating a plurality of turbine vanes attached at an angle on the solid swept area to capture, direct, concentrate and expel a vortex through each vane exhaust port, characteristics that dramatically increase the centrifugal force generated and the overall efficiency of the turbine.

Still another object of the invention is to provide a wind turbine that is self-starting, direct drive, exceptionally quiet, much more effective at lower wind speeds than conventional wind turbines, more tolerant of extreme wind conditions, and due to its solid swept area and much smaller diameter less dangerous to wildlife and more adaptable to marine applications.

Finally, another object is to provide a wind turbine having a field of use including rooftop, open field/ground, ocean sea level and submersible water current applications and which may also be stacked conveniently vertically or horizontally on a single support structure.

### BRIEF SUMMARY

The following summary is provided to facilitate an understanding of some of the features unique to the invention and is not intended to be a full description. A full appreciation of the various aspects of the invention can be gained only by taking the entire specification, claims, drawings, and abstract as a whole.

In accordance with the present invention and in fulfillment of the foregoing objects, a novel conical solid swept area wind turbine rotor is provided, the design employing long and short turbine vanes attached to the solid surface on an angle displaced from the axis and in circumaxially spaced relationship around the conical rotor. This combination allows for substantially 100% of the wind within the swept area to be captured, re-directed, concentrated, and exhausted through the turbine vane exhaust ports. The conical turbine rotor and vanes rotate as a unit, with each turbine vane strategically angled and located with its exhaust port positioned to discharge a wind vortex along and beyond the perimeter of the rotor and on an axis parallel to the surface of its vane thereby dramatically enhancing rotor performance.

The conical turbine rotor is more efficient at all wind speeds and particularly at very low wind speeds. The wind that passes unimpeded through traditional wind turbine blades is captured by the conical turbine rotor, increasing the torque and rotational force. The conical turbine rotor may be constructed from FRP, carbon fiber, aluminum or composite fabric. The rotor may be oriented into the wind by the use of a tail vane or yaw system.

### BRIEF DESCRIPTION OF THE DRAWINGS

FIG. 1 is a front view of a conical wind turbine rotor,

FIG. 2 is a rear view of the rotor,

FIGS. 3A and B are front and rear perspective views respectively of a long turbine vane showing the sail shape of the turbine vane, its reduced exhaust port configuration, and its leading and trailing edges,

FIGS. 4A and B are front and rear views respectively of a similar shorter turbine vane, the dashed lines representing the overall length of the short turbine vane in comparison to the overall length of long turbine vane,

FIG. 5 is a perspective view showing a complete wind turbine support and generator installation.

### DETAILED DESCRIPTION

The details shown and discussed in the following illustrative example may vary widely and are not intended to limit the scope of the invention.

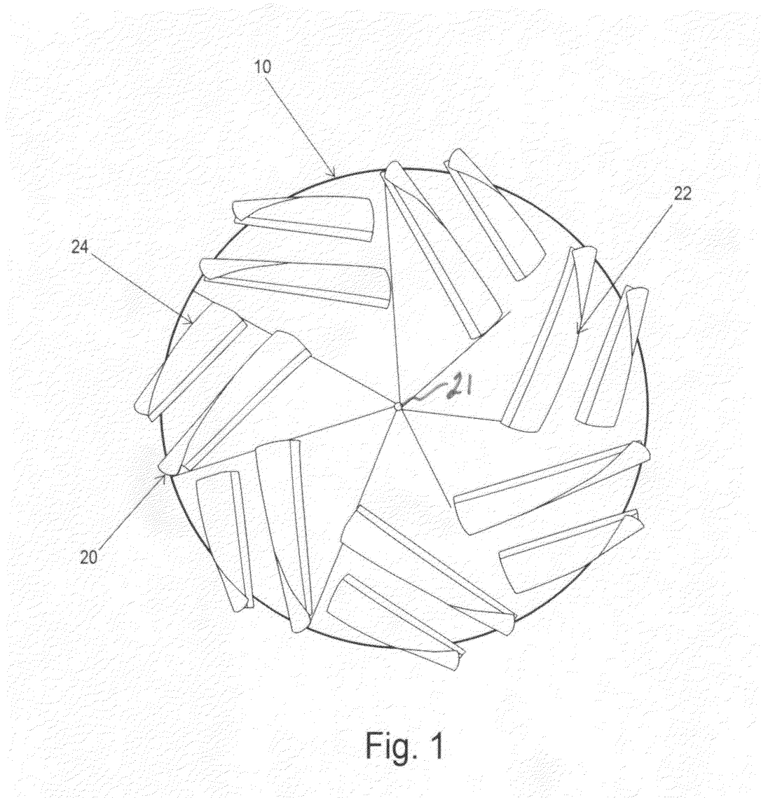

In FIG. 1, a front view of a horizontal axis conical wind turbine rotor is indicated generally at 10. The rotor has a plurality of circumaxially spaced relatively long vanes 22, 22, seven shown, each of which is angularly spaced from rotor axis 21, and seven similar but shorter vanes 24, 24. Each of the fourteen turbine blades has a progressively curled configuration with a reduced parti-circular exhaust port 20 at its downstream end located at or beyond the base perimeter of the rotor. With the vanes positioned at an angle on the presently preferred 20 degree slope of the conical rotor 10, the wind is directed by the rotor surface toward the entrances of the vanes 22, 22 and 24, 24 which in turn engage the wind, concentrate and exhaust the same as vortices through their exhaust ports 20, 20 resulting in a high level of centrifugal force, torque and RPM of the rotor.

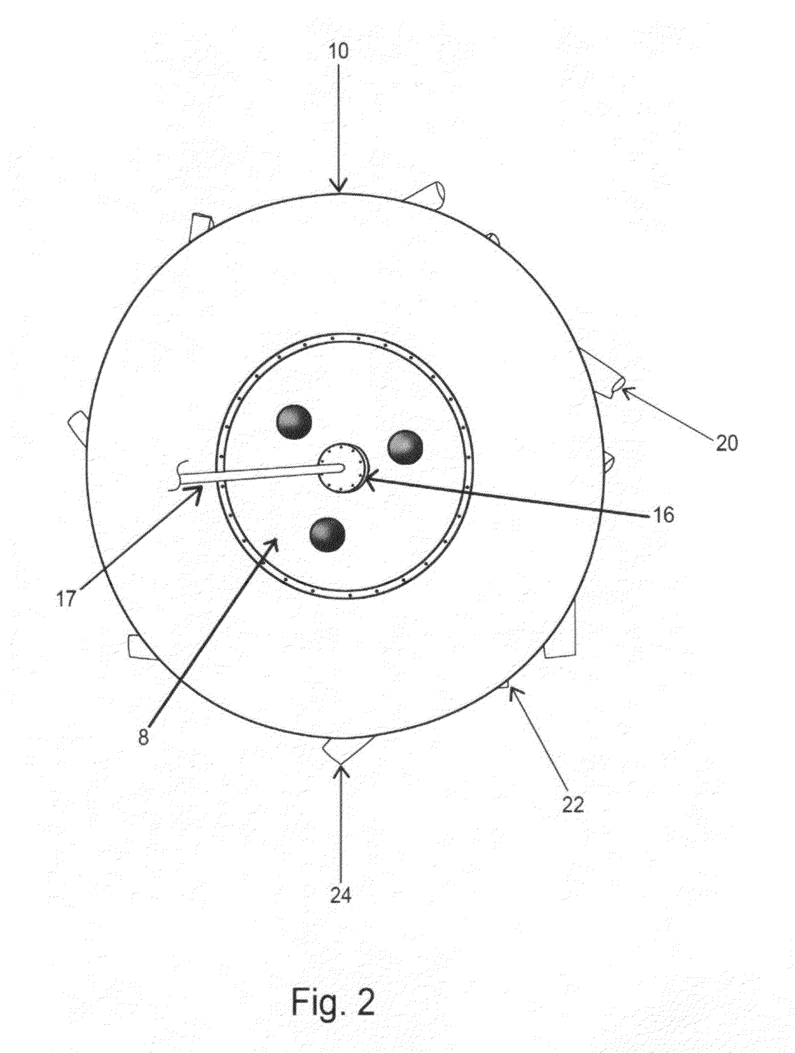

In the FIG. 2 rear view of the turbine rotor 10, the discharge ends of the vanes can be seen extending slightly beyond the perimeter of the rotor. The wind increases in speed as it passes over the sloped surface of the conical rotor 10 and is deflected and redirected through the vanes and then discharged in the form of a vortex beyond the perimeter of the conical rotor 10. As mentioned, this results in exceptionally high centrifugal force, torque and RPM generated by the rotor.

Further in FIG. 2, rear support plate 8 is shown attached to the back of the rotor 10 for structural integrity and for attachment of shaft 17. Shaft 17 may extend inside to nose of the rotor to its apex. Flange 16 may be welded to shaft 17 and bolted to rear support plate 8. All of the aforementioned parts are assembled and rotate as a single unit with shaft 17 connected to and driving an alternator or generator with or without a transmission.

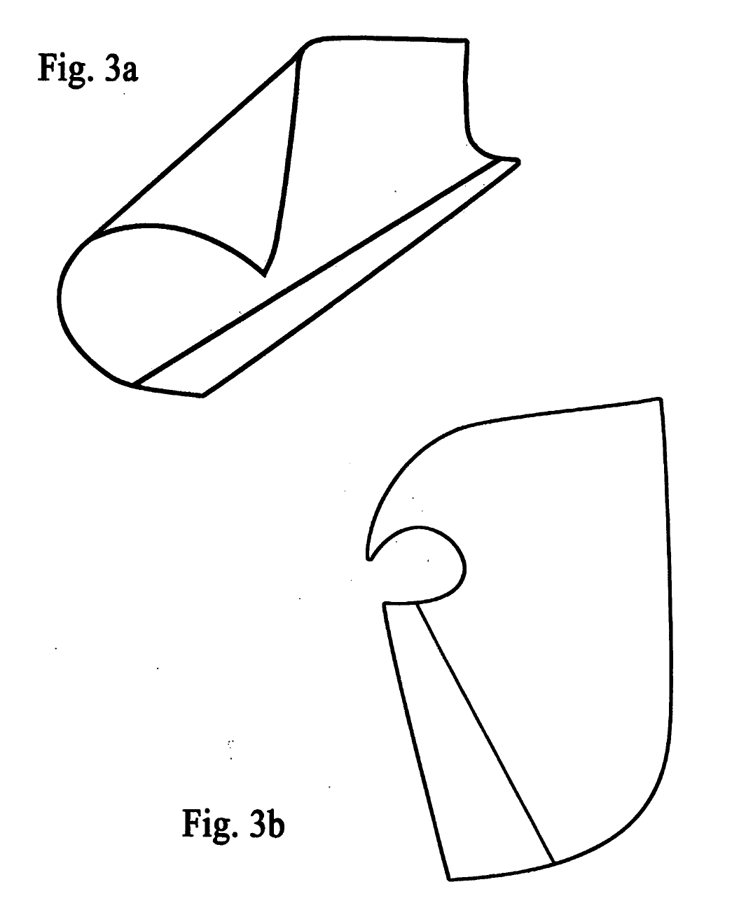

In FIGS. 3A and B a single long turbine vane 22 has substantially the same configuration as a shorter turbine blade 24. However, the overall length of short turbine blade 24 is preferably about 60% of the overall length of long turbine blade. The side and rear views illustrate a generally rectangular sail-like shape of the turbine vanes and a gradually curled reduced end portion forming a parti-circular exhaust port which creates a concentrated vortex discharge. The long and short turbine blade leading edges 25, 25 are substantially displaced angularly from the direction of wind flow. The long and short vane trailing edges 23, 23 are attached to the rotor 10 and preferably throughout their length.

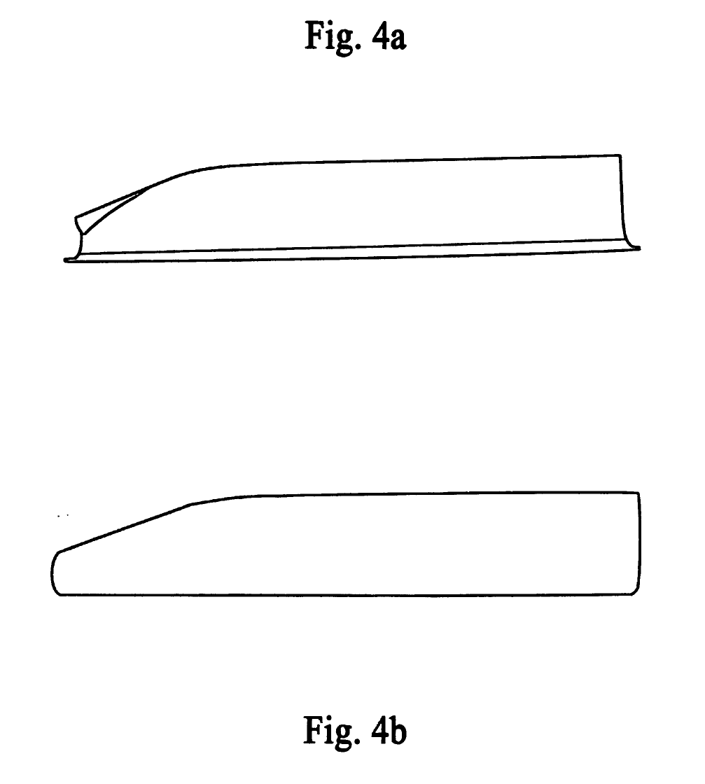

FIGS. 4A and B show front and back views of long turbine vane 22 and short turbine vane 24. The dashed line again represents the overall length of short turbine blade 24. The reduced discharge ends or exhausts ports 20, 20 are also shown, along with leading edges 25, 25 and trailing edges 23, 23.

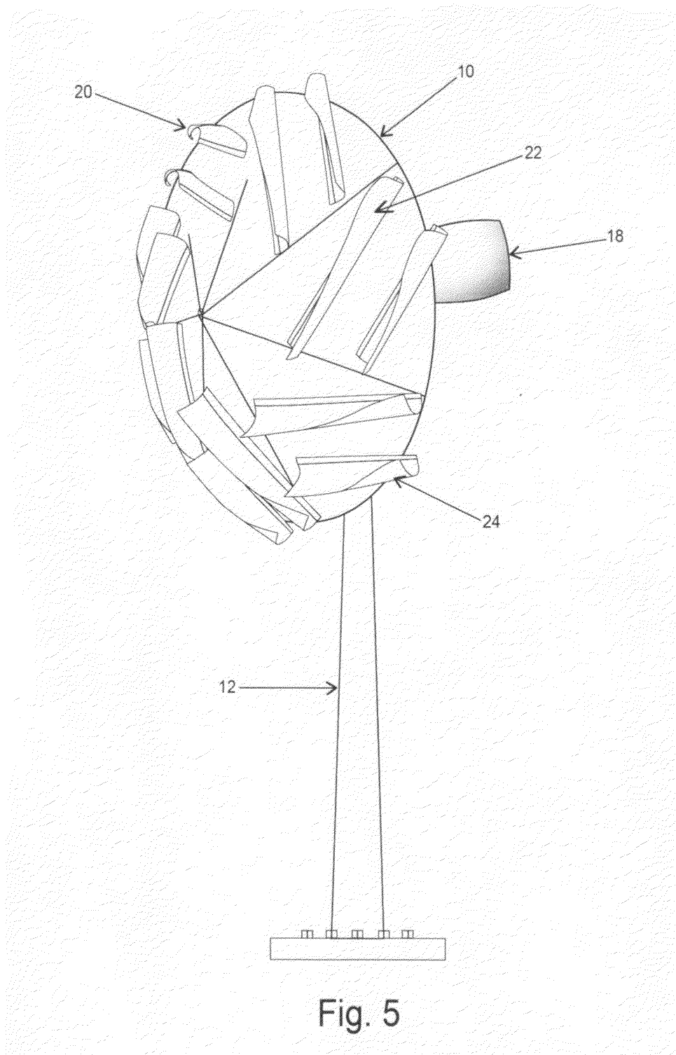

FIG. 5 is a perspective view of conical rotor 10 showing the long turbine vanes 22, 22 and short turbine vanes 24, 24 with rear alternator/generator 18 attached. The entire assembly represents an upwind turbine system (downwind also available) supported by monopole tower 12, and may be oriented into the wind by a yaw system. The conical rotor 10 acts as the main element converting kinetic energy of the wind into mechanical energy that is transferred to the alternator/generator to produce electricity.

As will be apparent from the foregoing, a wind turbine has been provided which has dramatically improved performance. Further, the turbine is extremely quiet in comparison with prior art turbines.

In the description above and in the claims which follow the term wind turbine should not be taken as limiting. The present invention is readily adaptable for use with any moving fluid, including liquids such as water and the like and gaseous mediums other than air.

1. A wind turbine comprising a rotor having a shallow slope cone configuration on a horizontal axis with its apex facing the wind and its base downstream, and a plurality of circumaxially-spaced wind-engaging vanes mounted on the surface of the conical rotor, each vane having an elongated substantially flat entry surface mounted on the surface of the rotor for engagement by the wind, the surface of the vane being displaced angularly front to rear from the axis of the rotor so as to be engaged by the wind and drive the rotor.

2. A wind turbine as set forth in claim 1 wherein each vane is angularly displaced from the axis of the rotor between 30 and 75 degrees.

3. A wind turbine as set forth in claim 1 wherein each vane is angularly displaced from the axis of the rotor between in the neighborhood of 45 degrees.

4. A wind turbine as set forth in claim 1 wherein each vane is curved gradually upon itself in progression from front to rear to provide at least a parti-circular discharge port which forms a vortex with its axis parallel with the vane.

5. A wind turbine as set forth in claim 4 wherein long and short vanes are arranged in pairs (groups) about the circumference of the conical rotor.

6. A wind turbine as set forth in claim 5 wherein the entrance ends of the pairs of vanes are offset relative to each other whereby to provide sequential wind engagement by the vanes.

7. A wind turbine as set forth in claim 6 wherein each pair of vanes has one long and one short vanes.

8. A wind turbine as set forth in claim 1 wherein the discharge ends of the vanes project at least to the peripheral edge of the rotor.

9. A wind turbine as set forth in claim 8 wherein the discharge ends of the vanes extend beyond the peripheral edge of the rotor.

10. A wind turbine as set forth in claim 9 wherein there are seven long and seven short vanes, with the long vanes arranged to engage the wind prior to engagement by the short vanes.
